(19) United States
(12) Patent Application Publication
(10) Pub. No.: US 2023/0245495 A1
(43) Pub. Date: Aug. 3, 2023

(54) Face recognition systems data collection process

(71) Applicant: VIETTEL GROUP, Ha Noi City (VN)

(72) Inventors: THI HUONG NINH, Vu Ban District (VN); VAN CHIEN THAI, Hung Nguyen District (VN); TIEN HAI TRAN, Ha Noi City (VN)

(73) Assignee: VIETTEL GROUP, Ha Noi City (VN)

(21) Appl. No.: 17/882,444

(22) Filed: Aug. 5, 2022

(30) Foreign Application Priority Data
Nov. 26, 2021 (VN) 1-2021-07623

(51) Int. Cl. G06V 40/16

(52) U.S. Cl. CPC G06V 40/161; G06V 40/168; G06V 40/172

(57) ABSTRACT

The semi-automatic data sample collection process for the face recognition system provides the facial data collection stages, made simple, easy to use in practice. The process includes the following main steps: reference image selection - frontal image of the sampled person’s face, adjusting the viewing angle to increase data diversity, automatic storage of image data and related information during sampling into the database. Thanks to automatic clustering, evaluation and storage, data collection time and effort are lowered, while confirming high accuracy. The adoption of centralized data storage in the future allows more convenience for users. Owing to its speed and convenience, the process can be applied in data collection for practical systems such as surveillance, face attendance with a very large number of people.

### 1. THE TECHNICAL FIELD SPECIFICATION

The disclosure acknowledges a semi-automatic data collection process for a face recognition system. The process considers how to collect data semi-automatically to train face recognition algorithms in detail. Initially, the process uses state-of-the-art deep learning models for facial features detection and extraction, and then predicts face orientation. Next, the depth-first search algorithm and data storage techniques are used that focus on structural databases.

### Patent Technical Status

Data plays an extremely important role generally in machine learning and particularly face recognition issues. The data required for this problem necessitates a variety of distributions, so that deep learning models can learn the hidden properties of the data thus producing more accurate predictions in practice. However, data collection for the face recognition problem demands a huge workload, primarily from labeling the data when the number of people is enormous. Additionally, the resulting quality evaluation of the sample obtained also remains an important concern.

Among the published patent documents, there are several works related to face data collection. However, the related inventions still have got some shortcomings and limitations, such as:

The U.S. Pat. No. 8031914 B2 issued on Oct. 4, 2011 proposes a method to help reduce labeling time when data is enormous that presents a clustering algorithm for face image data. Labeling process will be performed on a cluster of faces with high similarity instead of labeling individual images. Although time required is decreased, the labeling performance depends on the results of the clustering. For each cluster, there are still occurrences of interference cases (faces in the same cluster that do not belong to the same person). Furthermore, the passive sampling results in mediocre obtained data (blurred image, low diversity, data imbalance between each person), which leads to inaccurate data prediction.

The Chinese Published Patent Application No. CN 106204779 A on Aug. 31, 2018 proposes how to collect data via videos. Each person is recorded video data for about 30 seconds with different actions, then face image data will be extracted from this video. However, the proposed approach has not mentioned the problem of validating the diversity and quality of the obtained data. In addition to facial information, videos can contain many other unnecessary information, leading to challenges in storing in recognition systems with numerous numbers of people.

To overcome these deficiencies, the authors propose a novel semi-automatic data sample collection process for the face recognition system, which is different from any other published invention.

### 2. THE PATENT TECHNICAL NATURE

The purpose of the present invention is developing a semi-automatic data sample collection procedure for a facial recognition system, which helps tackle the previous inventions issues, therefore reducing the time and effort of data collection while ensuring the quality of the data, and enabling deep learning models to accurately predict in real-life applications. Moreover, data is systematically stored and convenient for future usage. The process is constructed on computer software, hence being easy to install and use.

To this end, the process proposed in the present invention is carried out through the following stages:
Stage 1: Select a reference image - a frontal image of the sampled person’s face.
Stage 2: Vary the viewing angle to increase the diversity of the data. Assess the quality of the acquired face data automatically by passing the filter to the face direction and comparing the similarity with the reference image, the process of clustering the obtained data in stages until the number of images collected system requirements are met.
Stage 3: Automatically store image data and related information during sampling into the database.

In particular, the semi-automatic face data sampling process has the following characteristics:
Except for the collection of only one reference image, all other steps are performed automatically. This reduces the labeling effort of system developers.
Data evaluation is done automatically through deep learning models, so the data is evaluated from a computer’s perspective instead of a human’s. Because the computer considers the images as a three-dimensional matrix, processes them in detail to each pixel different from the human eye view, so this automatic assessment helps lowering human effort, while enabling the computer to generate the data to facilitate the machine learning training process more effectively.
The approaches of face detection, feature extraction and face orientation estimation are all using state-of-the-art deep learning models with high accuracy and processing speed. The angle parameter from the face direction prediction model is utilized for removing faces with a large angle, which results in recognition information absence. The data is clustered based on the depth-first search algorithm with the original vertex as the reference image, which ensures that the computer can identify the faces in the same cluster as belonging to the same person.
Adopting techniques to optimize the processing speed of deep learning models such as face detection, feature extraction, face orientation estimation and clustering algorithms, the automatic sampling process responds in real time.
Stored data includes images and information about the sampling process (information about people being sampled, time, and location) on a database located at the server, for convenient use and query data in the future.

With the above-mentioned characteristics, this process can overcome the hurdles of previous sampling methods, while minimizing human effort in the data preparation process, and gaining data of high diversity. In actual implementation, using the process helps to average the sampling time to 30 seconds per person with image data from the 15 frames per second camera.

### 3. FIGURE BRIEF DESCRIPTION

FIG. 1 is an illustration of the semi-automatic face data collection process.

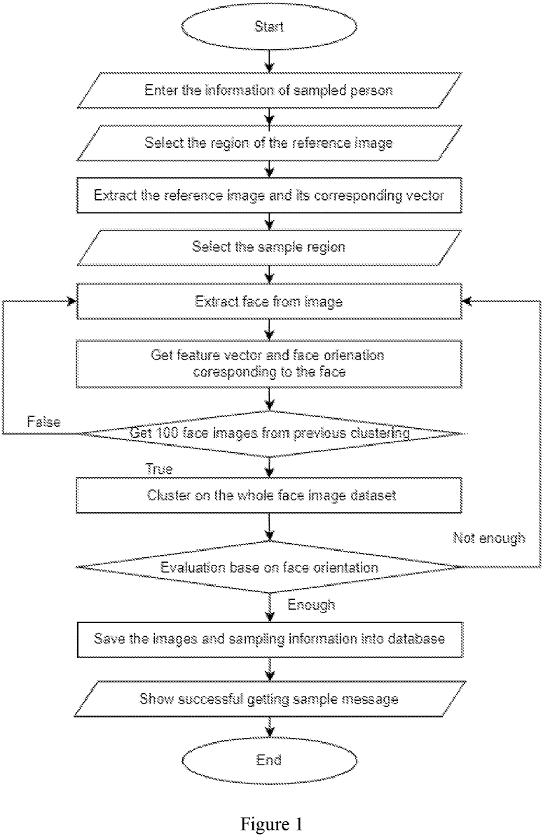

### 4. INVENTION DETAILED DESCRIPTION

The invention comprises a semi-automatic face data collection process with the ability to read images from the camera and display them on the screen, and can deploy deep learning models for the sampling process. Deep learning models designed based on convolutional neural networks are referred as follows:
Model of face detection in image: called RetinaFace, takes as input an image and outputs the coordinates of the upper left and lower right points of the faces detected in the image, with information about the coordinates of the eyes, nose and corners of the mouth of this face.
Model for extracting facial features: accepts as input a face image with size 112x112, and outputs a feature vector corresponding to 512 dimensions. The model uses the ArcFace loss function, with the aim of mapping data points onto spherical space, and data points of the same class will be close to each other and far away from points of other layers in angular space.
Face orientation estimation model: the input is a face image and the output is the value of three Euler angles representing the yaw, pitch and roll directions of the face.

The models are trained on large datasets, achieving high accuracy and generalizability when applied to real applications.

The details of the steps of the invention are described as follows:

Stage 1: selecting a reference image - a frontal image of the sampled person’s face.

After entering identification information for the person that is being sampled, the person performing the process will manipulate an region around the face of the sampled person for processing to determine a frontal image as a reference. The face detection model will output rectangular coordinates around the face image region. Selecting a small processing region increases processing speed and avoids other faces that interfere with the data. When the reference image selection is completed, the image will be passed through the feature extraction model to generate the feature vector as the reference data.

Stage 2: automatic data collecting.

After the reference data is available, the sampled person will be asked to perform the viewing operation from left to right direction. The person performing the process will perform a selection of the region around the face for processing. The collected face data is automatically evaluated according to the following theoretical basis:

The detected face image will be resized to 112×112 and passed through the feature extraction model and face orientation estimation model, obtaining information about the feature vector and the corresponding horizontal rotation angle of the face.

The undirected graph G = (V, E) represents the association between the corresponding data points which are face images, with V being the set of images and E being the set of edges. Consider a pair of vertices u and v belonging to the set V, corresponding to two images in the acquired face dataset. The pair of vertices u and v are considered to be two face images belonging to the same person if they have a high similarity and have a value greater than the threshold . The similarity of two images is calculated based on the angular distance between the two corresponding feature vectors, with the following formula:

$$cos i n e \_ s i m i l a r i t y \left(u , v\right) = \frac{\left〈f e a t \left(u\right) , f e a t \left(v\right)\right〉}{\text{P} f e a t \left(u\right) \text{P} * \text{P} f e a t \left(v\right) \text{P}}$$

where feat(u) and feat(v) are the facial feature vector respectively with the input image u, v. In the embodiment of the invention, feature vectors are normalized, for example feat(u) is transformed to ƒ(u) = ƒeat(u)/ Pu P. So the similarity between the two images u and v is now calculated as the dot product between the two normalized feature vectors:

$$cos i n e \_ s i m i l a r i t y \left(u , v\right) = \left〈f \left(u\right) , f \left(v\right)\right〉$$

For all pairs of vertices (u, v), if cosine_similarity(u, v) >= threshold, we construct the edge between these two vertices. The graph is built with the vertex set as the collected image data set, and the edge between the two vertices represents that the two face images corresponding to those two vertices belong to the same person. After building the graph, from the original vertex is the reference image, conduct depth-first search to find a connected subgraph consisting of images considered by the computer to be the same person. The detailed description of this search is as follows:
Construct the array num neighbors where num_neighbors[u] is the number of vertices adjacent to u.
Traverse the graph from the original vertex (the vertex corresponding to the reference image).
With vertex u being browsed. Then, consider all vertices v adjacent to u, if num_neighbors[v] < MIN_SAMPLE, remove vertex v. Otherwise, continue traversing vertex v. The process terminates when all vertices reachable from the original vertex have been traversed. The visited marked vertices correspond to the retained images.

The purpose of this process is to automatically collect good quality images, discarding poor quality images from the computer’s perspective. This process also eliminates noise images, such as other people accidentally appearing in the detection region during acquisition. Images with the number of images with high similarity less than the threshold (MIN_SAMPLE) will be removed to avoid noise cases. In the present invention, the authors set the threshold of similarity between two images threshold is 0.65 and the threshold number of neighbors of a MIN_SAMPLE vertex is N/100 where N is the total number of images being reviewed. The value of 0.65 of threshold was chosen by the authors during the experimental process when evaluating the similarity between two images belonging to the same person and between two images belonging to two different people. This value is the most optimal value on a small data set, lower than 0.65 will cause the computer to mistake two images of two different people as the same person, and higher than 0.65 will increase the rate of mistakenly recognizing two photos belonging to the same person as two different people.

To automatically validate and assure the diversity of the clustered data sample, the method used is to calculate the number of faces for orientation intervals. The yaw angle with the value in the interval [-50, 50] is divided into five bins:
Left bin: values in the half range [-50, -40);
Semi-left bin: values in the half range [-40, -20);
Frontal bin: values in the range [-20, 20];
Semi-right bin: values in the half range (20, 40];
Right bin: values in the half range (40, -50].

According to an embodiment of the present invention, the dataset is said to be sufficiently diverse if the number of images belong to frontal bin is greater than or equal to 30, the semi-left and semi-right bins have a number of images greater than or equal to 25, and the left and right bins have a number of face images greater or equal to 5. Images with yaw angles outside this range are discarded. The above quantities are used to ensure data quality, and minimize sampling time as well as reduce storage space and time when processing data in the future (training for machine learning and deep learning models, search or query data).

The process of collecting, clustering and evaluating ends when the required number of images for face orientation intervals is reached. Since the process of performing clustering takes a long time, to ensure real-time processing, according to an embodiment of the present invention, this process is only performed after receiving 100 images compared to the previous cluster.

Stage 3: store image data and sampling information.

After the automatic data collection is over, the image data and sampling information are stored in the server system for convenience for future use. Image data is saved to the MinIO database. Information about sampled people (full name, identifier, email address, phone number, date of birth, gender, other notes...) and collected mold image information (sampling time, location, image link at MinIO, coordinates of face in original image, image size, coordinates of eye points, nose, mouth, feature vector, face orientations) are stored in a PosgreSQL database. Information about the sampled person and the facial images respective to that person are linked together for easy querying. After successful storage, the screen will display a message that sampling has been completed.

Data is stored centrally on the server system, making the data unified, highly manageable and easily shared. Users are granted access to a server that is able to query and download data remotely via a network connection.

In this process, the sampler only needs to perform reference image selection and region selection for human detection. The collection and evaluation as well as storage of large amounts of data is done automatically with high processing speed. This ensures data diversity, sampling time, and minimizes labeling effort.

### Examples of Implementation

The following section gives an example of performing a sampling and evaluation procedure on a face recognition system, which is intended for clarification without imposing any limitations on the proposed invention.

The data collection process is applied on 4 K quality cameras at five frames per second set up in a building. Deep learning models are performed on a high configuration computer with Quadro P4000 graphics cards. The number of people sampled is nearly 500 people.

The average sampling time for one person is about one minute and the selection of the reference images as well as the regions from those images takes only 10 seconds. On average, about 100 photos are obtained for each person with different face angles. The face recognition model uses the acquired data to train and achieves 99.99% accuracy on a dataset consisting of more than 250000 daily photos of 455 people (to ensure objective assessment, datasets). This is labeled for each photo actually obtained with each person’s camera within five days, so the dataset may not be full of people who need samples and the obtained face images are not diverse). When compared in terms of implementation time, self-labeling took five days for the daily data collection of employees in the building from 84 cameras, and five people for two weeks for labeling 250,000 extracted face images. However, the number of people sampled is not sufficient, there are not enough cameras to cover all angles, and the data obtained is not diversified enough.

### Technical Efficiency Achievement

The semi-automatic face sampling procedure proposed in the patent has dealt with two necessities in the face recognition problem using deep learning models: building a diverse, inclusive dataset and reducing data collection and labeling time. The process is simply designed and packaged into software for ease of use. Therefore, the process can be widely applied in practice, when the number of people reaches hundreds, thousands of people. Furthermore, the process exploits state-of-the-art deep learning algorithms with high accuracy and low processing time in the tasks of face detection, face feature extraction and face orientation estimation. Thanks to the high processing speed of the algorithms and the automatic collection and evaluation process, the sampling is done quickly and without human intervention. Although the data obtained is small, it still ensures the diversity and generalization of face orientation cases. As a result, the accuracy in face recognition is increased compared to the previous methods of collection without evaluation of data quality, while the time and effort to perform sampling is significantly reduced.

Storing data in the recommended procedure helps to facilitate future querying. Thanks to centralized storage on a server system, data is stored in a unified way, easily managed and can be accessed by many users. Furthermore, thanks to this storage, multiple people can be sampled at the same time at different camera positions without conflict.

1. A semi-automatic sampling process for a face recognition system comprising the steps of:
step 1: select a reference image - a frontal image of a sampled person’s face; After entering identification information for the sampled person, manipulating a face image region around the face for processing to determine a frontal image as a reference image;
step 2: change the viewing angle to increase the diversity of the data; evaluate the quality of the acquired face data automatically by passing a filter to the face direction and comparing similarity with the reference image, clustering the acquired data in stages until a number of images collected system requirements are met;
step 3: automatically store image data and related information during sampling into a database; After the automatic data collection process ends, storing the image data and sampling information in a server system for the convenience of future use.

2. The Semi-automatic data collection process for face recognition system according to claim 1, in which in step 1:
A face detection model is provided to output rectangular coordinates around the face image region; small selection of processing region increases processing speed and avoids other faces that interfere with data; When completing the selection of the reference image, the image will be passed through a feature extraction model to create a feature vector as a reference data.

3. The Semi-automatic data collection process for face recognition system according to claim 1, in which in step 2:
after the reference data is available, having the face sampled subject perform a viewing operation from a first direction to a second direction; selecting a region around the face for processing; automatically evaluating the collected face data on the following basis:
The detected face image is resized to 112x112 and passed through a feature extraction model and a face orientation estimation model, obtaining information about the feature vector and a corresponding yaw angle of the face;
An undirected graph G = (V, E) represents the connection between the corresponding data points which are face images, with V being a set of images, E being a set of edges; consider the pair of vertices u and v belonging to the set V, corresponding to the two images in the obtained face data set; the pair of vertices u and v are considered to be two face images belonging to a same person if they have high similarity and have a value greater than a threshold; similarity of two images is calculated based on an angular distance between two corresponding feature vectors, with the following formula:
$$cos i n e \_ s i m i l a r i t y \left(u , v\right) = \frac{\left〈f e a t \left(u\right) , f e a t \left(v\right)\right〉}{∁ f e a t \left(u\right) ∁ ∗ ∁ f e a t \left(v\right) ∁}$$
Where feat(u), feat(v) are the face feature vectors corresponding to the input image u, v; wherein feature vectors are normalized, Therefore, the similarity between the two images u and v is now calculated as the dot product between the two normalized feature vectors:
$$cos i n e \_ s i m i l a r i t y \left(u , v\right) = \left〈f \left(u\right) , f \left(v\right)\right〉$$
for all pairs of vertices (u, v), if cosine_similarity(u, v) > = threshold, the edge between these two vertices is constructed; The graph is built with the vertex set as the collected image data set, and the edge between the two vertices shows that the two face images corresponding to those two vertices belong to the same person; after building the graph, from the original vertex is the reference image, conducting a depth-first search to find a connected subgraph consisting of images considered by a computer to be the same person; wherein the depth-first search is as follows:
construct an array num_neighbors where num_neighbors[u] is a number of vertices adjacent to u;
traverse the graph from the original vertex (the vertex corresponding to the reference image);
with vertex u being browsed. Then consider all vertices v adjacent to u, if num_neighbors[v] < MIN_SAMPLE, remove vertex v; otherwise, traverse vertex v; the process ends when all vertices reachable from the original vertex have been traversed; visited marked vertices correspond to retained images;
The images with the number of images with high similarity with it less than the threshold (MIN_SAMPLE) is removed to avoid noise cases;
to automatically evaluate and ensure the diversity of the clustered data sample, the method used is to calculate the number of faces for orientation intervals; The yaw angle with the value in the interval [-50, 50] is divided into five bins:
a left bin: values in the half range [-50, -40);
a semi-left bin: values in the half range [-40, -20);
a frontal bin: values in the range [-20, 20];
a semi-right bin: values in the half range (20, 40];
a right bin: values in the half range (40, -50];
The data set is said to be sufficiently diverse if the number of images belonging to the frontal bin is greater than or equal to 30, the semi-left and semi-right bins have a number of images greater than or equal to 25, and the left and right bins have a number of face images greater or equal to 5; images with yaw angles outside this range are discarded; The above quantities are used to ensure data quality, and minimize sampling time as well as reduce storage space and time when processing data in the future (training for machine learning and deep learning models, search and query data);
the process of collection, clustering and evaluation ends when the number of images for face orientation intervals is reached; Because the process of performing clustering takes a long time, to ensure real-time processing, according to an embodiment of the present invention, this process is only performed after receiving 100 images compared to a previous cluster.

4. The Semi-automatic data collection process for face recognition system according to claim 1, in which in step 3:
image data is saved to a MinIO database; information about sampled people (full name, identifier, email address, phone number, date of birth, gender, other notes...) and collected mold image information (sampling time, location, image link at MinIO, coordinates of face in original image, image size, coordinates of eye points, nose, mouth, feature vector, face orientations) stored in a PosgreSQL database; information about the sampled person and the photo corresponding to that person are linked together for easy querying; after successful storage, a screen will display a message that sampling has been completed;
data is stored centrally on the server system, making the data unified, highly manageable and can be easily shared; users are granted access to a server capable of querying and downloading data remotely via a network connection;
in this process, the sampler only needs to perform reference image selection and face region selection for human detection; the collection and evaluation as well as storage of large amounts of data is done automatically with high processing speed; This ensures the diversity of the data, the sampling time as well as minimizes the effort of labeling.

5. The Semi-automatic data collection process for face recognition system according to claim 1, in which the process of clustering and evaluating face orientation diversity is performed after collecting 100 images compared to the previous cluster to strike a balance between the sampling time and the computational cost of the computer.

6. The Semi-automatic data collection process for face detection system according to claim 1, where the threshold for determining two images as similar is 0.65, the threshold for the number of similar images of a vertex to decide whether the image is similar whether selected or not is the total number of photos/100.
